(19) United States
(12) Patent Application Publication
(10) Pub. No.: US 2019/0153846 A1
(43) Pub. Date: May 23, 2019

(54) High Pressure Filtration

(71) Applicants: M-I L.L.C., Houston, TX (US); M-I DRILLING FLUIDS UK LTD, Aberdeen (GB)

(72) Inventors: George Stewart, Aberdeen (GB); Charles Svoboda, Katy, TX (US)

(21) Appl. No.: 16/196,767

(22) Filed: Nov. 20, 2018

Related U.S. Application Data
(60) Provisional application No. 62/588,863, filed on Nov. 20, 2017.

(51) Int. Cl. E21B 43/34; B01D 29/56; B01D 35/06

(52) U.S. Cl. CPC E21B 43/34; B01D 29/56; B01D 2239/1291; B01D 2221/04; B01D 2239/1216; B01D 35/06

(57) ABSTRACT

A technique to facilitate removal of various types of particulates from fluids during well operations. The technique may employ a skid positioned at a surface location. A filtration system is mounted on the skid to enable filtration of particulates as the subject fluid flows from a system inlet to a system outlet. The filtration system comprises a bank of filtering stages arranged generally horizontally on the skid. For example, a first stage may be constructed with a generally horizontal vessel containing a first filter arranged to filter particulates from the fluid. The first stage also may comprise a magnet positioned to retain ferrous debris. Additionally, a second stage receives fluid exiting from the first stage and contains a second filter for further filtering of particulates from the fluid.

### CROSS REFERENCE TO RELATED APPLICATIONS

This application claims the benefit of priority to U.S. Provisional Patent Application 62/588,863, filed on Nov. 20, 2017, the entire content of which is incorporated herein by reference.

### BACKGROUND

In many well applications, various types of fluids are pumped during well servicing operations, production operations, and other well related operations. The fluid may contain different particulates which can be damaging to well equipment. During a workover, for example, well fluids are pumped downhole and may accumulate a range of particulates such as ferrous and non-ferrous metals, scale, drilling debris, and cementation debris. A number of filtration and separation solutions, e.g. downhole filters, have been used in an attempt to remove the particulates. In these operations, the fluids pumped are at high pressure and the filters are exposed to high stresses.

### SUMMARY

In general, a system and methodology are provided for filtering various types of particulates from fluids during well operations. According to an embodiment, the technique employs a skid positioned at a surface location. A filtration system is mounted on the skid to enable filtration and the removal of particulates as the subject fluid flows from a system inlet to a system outlet. The filtration system comprises a bank of filtering stages arranged generally horizontally on the skid. For example, a first stage may be constructed with a generally horizontal vessel containing a first filter arranged to filter particulates from the fluid. The first stage also may include a magnet positioned to retain ferrous debris. Additionally, a second stage receives fluid exiting from the first stage and contains a secondary filter for further filtering of particulates from the fluid. In some applications, the first stage is located above the second stage.

Many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a system for filtering combining an example of a skid and a filtration system mounted on the skid, according to an embodiment of the disclosure;

FIG. 2 is an end view of an example of a system for filtering, according to an embodiment of the disclosure; and

FIG. 3 is a side view of the system illustrated in FIG. 2, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology which facilitate filtering of fluids in various well applications. For example, the technique may provide a surface filtration system which can be used to filter well workover fluids. In many applications, the surface filtration system provides an easy to use system at a surface location with performance that at least matches the performance of downhole screens.

In various applications, the filtration system provides a pressurized fluid filtration system having a combination of high pressure vessels, valves, and manifold distribution. The construction may be a modular construction utilizing a combination of filters and magnetic retention to aid in the intervention and retention of ferrous and non-ferrous metals, scales, drilling debris, cementation debris, and/or other particulates. The construction provides a straining and retaining functionality which may include magnetic field alignment to increase the capture of particulates while maintaining flow channels around the captured debris.

According to an embodiment, a system and methodology are provided for filtering various types of particulates from fluids during well operations, e.g. well workover operations. In one embodiment, the technique employs a skid positioned at a surface location. A filtration system is mounted on the skid to enable filtration of particulates as the subject fluid flows from a system inlet to a system outlet. The filtration system comprises a bank of filtering stages arranged generally horizontally on the skid. For example, a first stage may be constructed with a generally horizontal vessel containing a first filter arranged to filter particulates from the fluid. The first stage also may comprise a magnet positioned to retain ferrous debris. Additionally, a second stage receives fluid exiting from the first stage and contains a second filter for further filtering of particulates from the fluid.

By way of example, the first stage and second stage may each utilize generally cylindrical vessels capable of handling high-pressure fluids. In some applications, the generally cylindrical vessels are arranged horizontally and stacked generally above each other, e.g. the first stage is positioned over the second stage. Additionally, a manifold system may be used to control flow of the fluid to the first stage and the manifold system may comprise a suitable configuration of block and bleed valves.

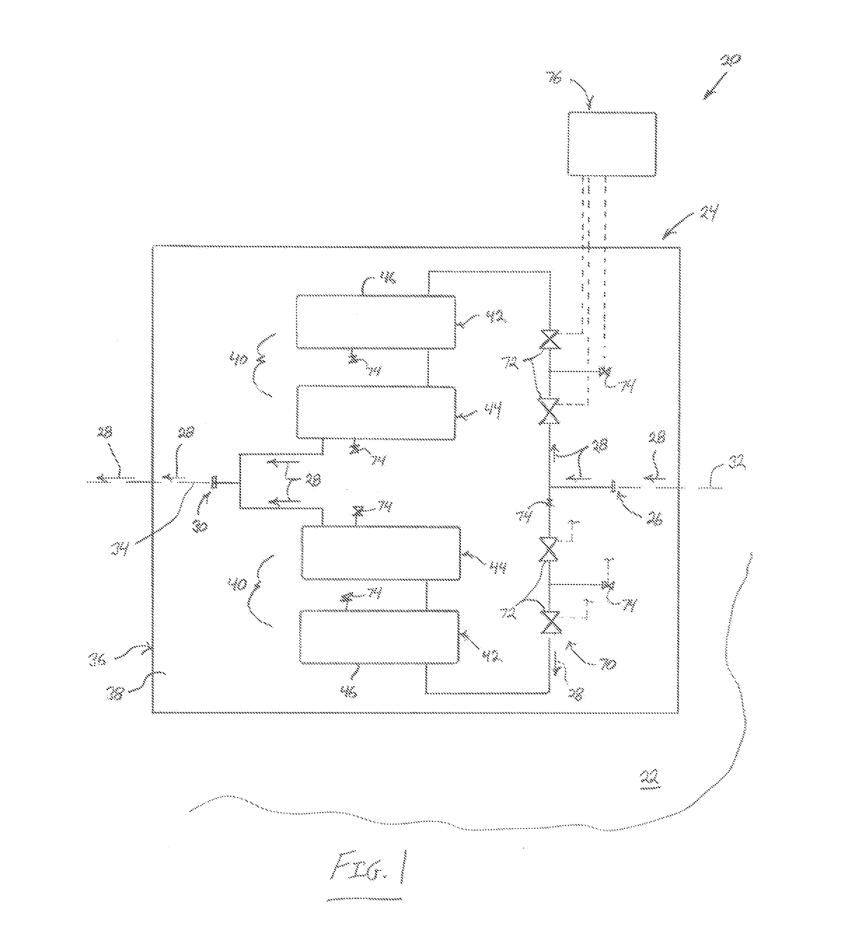

Referring generally to FIG. 1, a system 20 is illustrated schematically as a fluid handling system positioned at a surface location 22, e.g. a wellsite. The system 20 comprises a filtration system 24 having a system inlet 26 for receiving a fluid (represented by arrows 28) to be filtered. The filtration system 24 also has a system outlet 30 through which the fluid 28 is discharged after removal of particulates, e.g. ferrous and non-ferrous metals, scales, drilling debris, cementation debris. In the example illustrated, the system inlet 26 is supplied with unfiltered fluid 28 via a supply line 32 and, after filtering via filtration system 24, the fluid 28 is discharged into a flow line 34.

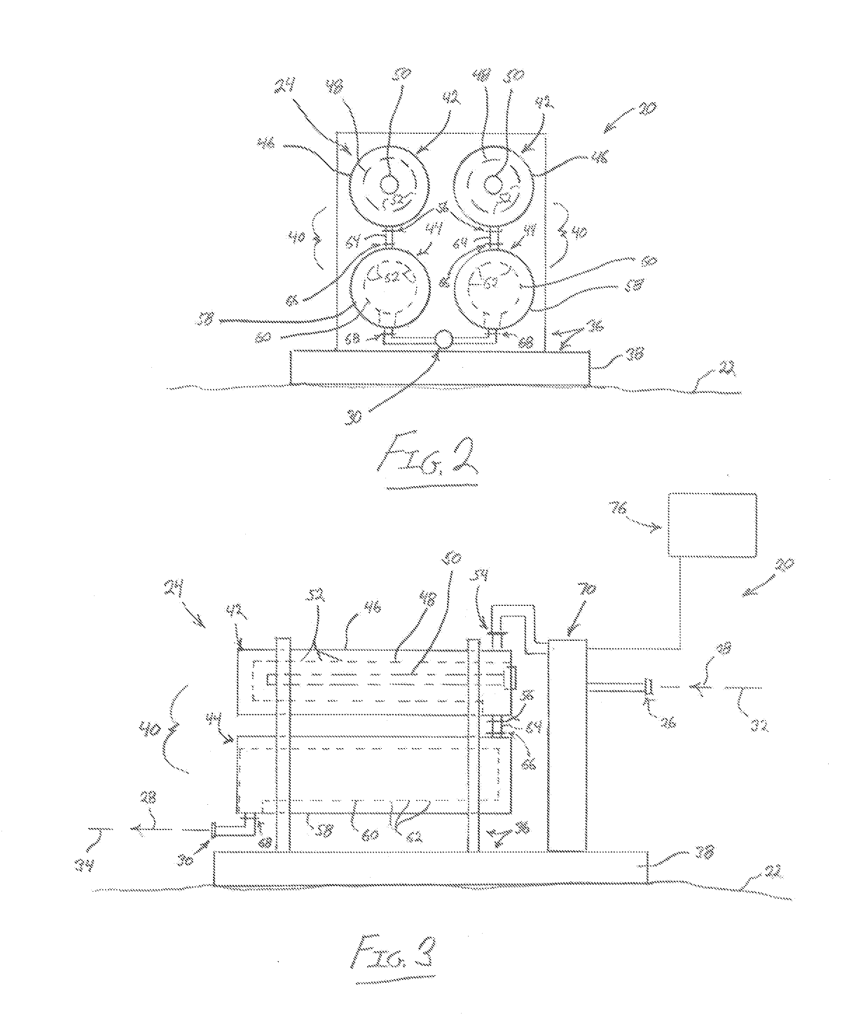

As further illustrated in FIGS. 2 and 3, the filtration system 24 may be mounted on a skid 36 which may have a base 38 configured for supporting the filtration system 24 at surface location 22. According to the embodiment illustrated, the filtration system 24 comprises a bank or a plurality of banks of filter stages 40. For example, each bank of filter stages 40 may comprise a first filter stage 42 and a second filter stage 44.

By way of example, the first filter stage 42 may comprise a vessel 46 arranged generally horizontally. The vessel 46 may be constructed as a pressure vessel able to handle high-pressure fluids and, in some embodiments, the vessel 46 may be generally cylindrical in shape. The first filter stage 42 may further comprise a filter 48 disposed within vessel 46 and arranged to filter particulates from fluid 28. The first filter stage 42 also may comprise a magnet 50 positioned within vessel 46 to retain magnetic articulates, such as ferrous debris.

Although the filter 48 may have various configurations, one embodiment utilizes a generally cylindrical filter having pores 52 of a predetermined size to filter out particulates of a desired size. Fluid 28 flows into the first stage vessel 46 through a vessel inlet 54 and is effectively forced through filter 48 before exiting vessel 46 via a vessel discharge 56.

By way of example, the magnet 50 may be disposed within the interior of cylindrically shaped filter 48. However, the magnet 50 may be located in the fluid flow path along an exterior of the filter 48 or at other suitable locations selected to facilitate removal of the ferrous debris. The magnet 50 also may comprise a single magnet or a plurality of magnets arranged at desired locations. In some embodiments, the magnet 50 and/or filter 48 may be constructed as removable components to facilitate cleaning and replacement. For example, an end of the pressure vessel 46 may be threadably engaged or otherwise removable to accommodate removal of the magnet 50 and/or filter 48.

When the fluid 28 exits vessel 46 via vessel discharge 56, the fluid is directed to the second filter stage 44. By way of example, the second filter stage 44 also may comprise a vessel 58 arranged generally horizontally. The vessel 58 may similarly be constructed as a pressure vessel able to handle high-pressure fluids. In some embodiments, the vessel 58 may be generally cylindrical in shape and positioned horizontally (see FIG. 3).

The second filter stage 44 may further comprise a second stage filter 60 arranged to filter additional particulates from fluid 28. The filter 60 may have various configurations, e.g. a generally cylindrical filter having pores 62 of a predetermined size to filter out particulates of a desired size. For example, pores 62 may be of a different size than pores 52 of the first filter 48. In some embodiments, the pores 62 may be smaller than pores 52 so as to filter additional particulates from fluid 28 after the initial filtering of fluid 28 in first filter stage 42.

As fluid 28 flows from discharge 56 of the first stage vessel 46, it moves through a connector passage 64 to a second vessel inlet 66 of second vessel 58. The fluid 28 then flows into vessel 58 and is effectively forced through filter 60 before exiting vessel 58 via a second vessel discharge 68. From second vessel discharge 68, the fluid 28 is directed to system outlet 30 and on into flow line 34. In some embodiments, the filter 60 may be constructed as a removable component to facilitate cleaning and replacement.

In the embodiment illustrated, the filtration system 24 comprises two banks of filter stages 40. However, the filtration system 24 may have a single bank of filter stages 40 or additional banks of filter stages 40, e.g. four or six banks of filter stages 40. Additionally, the first filter stage 42 may be an upper stage located above the lower, second filter stage 44, as illustrated. However, the first filter stage 42 may be positioned at other suitable locations relative to the second filter stage 44.

In some embodiments, the filtration system 24 also may comprise a manifold 70 located, for example, between system inlet 26 and the bank(s) of filter stages 40. By way of example, the manifold 70 may comprise a plurality of flow control valves, such as blocking valves 72 and bleed valves 74, as illustrated in FIG. 1. The blocking valves 72 may be operated to selectively control fluid flow to each bank of filter stages 40.

According to an example, a plurality of blocking valves 72, e.g. two blocking valves, is provided in the flow path of fluid 28 for each bank of filter stages 40. The blocking valves 72 may comprise gate valves, plug valves, or other suitable valves for selectively allowing or blocking flow of fluid between system inlet 26 and each bank of filter stages 40. Additionally, the manifold 70 may have at least one bleed valve 74 associated with each bank of filter stages 40. In some embodiments, additional bleed valves 74 also may be coupled with each of the first vessels 46 and the second vessels 58 to facilitate bleeding of fluids from the vessels when desired.

The blocking valves 72 and/or bleed valves 74 also may be automated and connected with an automated flow control system 76, such as a computer-based flow control system. In some embodiments, differential pressures may be monitored along the filtration system 24, e.g. between system inlet 26 and system outlet 30, to determine appropriate times for servicing filters 48, 60 or for performing other service operations. The differential pressures also may be monitored via control system 76.

Depending on the parameters of a given filtering operation, the number of banks of filter stages 40 may be adjusted. Similarly, the type, configuration, and size of filters 48, 60 may be selected according to the fluid characteristics, particulate characteristics, and/or environment in which the filtration system 24 is operated. The flow rates, operational pressures, skid configuration, and other operational parameters and configurations may be selected according to the type of operation and environment in which the overall system 20 is operated.

In various applications, the filtration system 24 may be used for filtering workover fluids used in a variety of well workover operations. However, the filtration system 24 may be used for filtering many other types of fluids. The filtration system 24 also may be mounted on various types of skids 36, at least some of which may be transportable from one wellsite to another. The surface location 22 has been illustrated as a wellsite, but the filtration 24 may be used at other surface locations and in other types of filtering operations.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for filtering, comprising:
a skid which may be located at a wellsite and positioned along a surface; and
a filtration system mounted on the skid to filter a fluid as the fluid passes from an inlet of the filtration system to an outlet of the filtration system, the filtration system comprising:
a bank of filtering stages having a first stage arranged to receive fluid from the inlet and a second stage arranged to receive fluid from the first stage and to discharge fluid to the outlet, the first stage having a first horizontal vessel containing a first filter located within the first horizontal vessel to filter particulates from the fluid and a magnet positioned to retain ferrous debris, the second stage having a second horizontal vessel containing a second filter.

2. The system as recited in claim 1, wherein the filtration system is used to filter particulates from well workover fluids received under high pressure.

3. The system as recited in claim 1, wherein the filtration system comprises two banks of filtering stages.

4. The system as recited in claim 1, wherein the filtration system comprises a plurality of banks of filtering stages.

5. The system as recited in claim 1, wherein the first horizontal vessel is located above the second horizontal vessel.

6. The system as recited in claim 1, wherein the first horizontal vessel and the second horizontal vessel are each cylindrical.

7. The system as recited in claim 1, wherein the filtration system comprises a manifold having a plurality of valves to control flow of fluid from the inlet to the bank of filtering stages.

8. The system as recited in claim 1, wherein the magnet is removable.

9. The system as recited in claim 1, wherein the first filter and the second filter have different pore sizes to filter particulates of differing sizes.

10. A system, comprising:
a filtration system having a plurality of banks of filtering stages disposed between a system inlet and a system outlet, each bank of filtering stages comprising:
an upper stage having: a first cylindrical housing oriented horizontally; a first filter positioned in the first cylindrical housing to filter particulates from the fluid; and a magnet positioned in the first cylindrical housing to retain ferrous debris; and
a lower stage having: a second cylindrical housing oriented horizontally; and a second filter positioned in the second cylindrical housing.

11. The system as recited in claim 10, wherein the filtration system is mounted on a surface skid.

12. The system as recited in claim 10, wherein the magnet is removable from the first cylindrical housing.

13. The system as recited in claim 10, wherein the filtration system comprises a manifold having a plurality of valves to control flow of fluid from the system inlet to the bank of filtering stages.

14. The system as recited in claim 10, wherein the first filter and the second filter have different pore sizes to filter particulates of differing sizes.

15. The system as recited in claim 10, wherein the plurality of banks comprises two banks of filtering stages.
